(19) United States
(12) Patent Application Publication
(10) Pub. No.: US 2024/0088760 A1
(43) Pub. Date: Mar. 14, 2024

(54) ELECTRIC MOTOR ARRANGEMENT FOR A MOTOR WITH A DRIVE

(71) Applicant: Danfoss Power Electronics A/S, Gråsten (DK)

(72) Inventors: Stefan Zöschg, Burgstall (IT); Patrice Rollin, Burgstall (IT); Dario Nanni, Nordborg (DK); Fabrizio Robol, Trento (IT); Lorenz Vorhauser, Nordborg (DK)

(21) Appl. No.: 18/461,003

(22) Filed: Sep. 5, 2023

(30) Foreign Application Priority Data
Sep. 9, 2022 (DE) 102022123028.7

(51) Int. Cl. H02K 11/33; H02K 5/22

(52) U.S. Cl. CPC H02K 11/33; H02K 5/225; H02K 2211/03

(57) ABSTRACT

An electric motor arrangement including an electric motor, in particular a servo integrated motor, an encapsulation containing a motor drive, in particular a servo drive, for driving the motor with a low impedance electrical conducting path comprising a stacked power module, a power PCBA and a power connector. The electric motor arrangement further includes an electric motor and first and second encapsulation portions containing a motor drive for driving the motor, wherein the first encapsulation portion, the second encapsulation portion and/or the motor are thermally separated from each other by at least one thermal isolating layer.

### CROSS-REFERENCE TO RELATED APPLICATION

This application claims foreign priority benefits under 35 U.S.C. § 119 from German Patent Application No. 102022123028.7, filed Sep. 9, 2022, the content of which is hereby incorporated by reference in its entirety.

### TECHNICAL FIELD

The present invention pertains to an electric motor arrangement comprising an electric motor, in particular a servo integrated motor, an encapsulation containing a motor drive, in particular a servo drive, for driving the motor with a low impedance electrical conducting path comprising a stacked power module, a power PCBA and a power connector. The electric motor arrangement may be a servo-drive.

The present invention also pertains to an electric motor arrangement comprising an electric motor and first and second encapsulation portions containing a motor drive for driving the motor, wherein the first encapsulation portion, the second encapsulation portion and/or the motor are thermally separated from each other by at least one thermal isolating layer.

### BACKGROUND

Electric motor arrangements comprise an electric motor and a motor drive for driving the motor. They provide compact and functional modules for driving any given mechanisms.

The development of smaller and more powerful motor drives leads to excessive heat generation by the motor drive. The temperatures of the motor drives may hence exceed acceptable temperature levels. As a result, the performance of the corresponding electric motor arrangement may be adversely affected. Problems such as thermal destruction or damage to the drive or other components of the electric motor arrangement may occur. Long-time excessive temperatures may also lead to reduced lifetime of individual components within the motor drive.

### SUMMARY

The aim of the present invention is to provide an improved electric motor arrangement, which overcomes the above problem and makes it possible to safely operate compact and power-dense electric motor arrangements.

This aim is achieved by electric motor arrangements according to a first aspect of the invention comprising the features of claim 1 and a second aspect of the present invention comprising the features of claim 16. Advantageous embodiments of the invention are subject to the dependent claims.

According to claim 1, an electric motor arrangement comprises an electric motor, in particular a servo integrated motor, an encapsulation containing a motor drive, in particular a servo drive, for driving the motor with a low impedance electrical conducting path comprising a stacked power module, a power PCBA and a power connector.

The present invention makes it possible to significantly reduce the heat dissipation of the electric motor arrangement compared to the state of the art, such that it can be managed within the specified, much reduced space. In order to reduce the heat dissipation, the impedance of the electrical conducting path may be lower than 50 mOhm, in particular between each power component. The electrical conducting path may correspond to or comprise the electric path between a power connector and the motor and/or components of the motor drive, such as the stacked power module.

To obtain the low impedance path on the PCBA, the individual components may preferably be arrange at such short distances with respect to each other that the components are almost touching one another. Their distances may be less than e.g. 1 mm.

The present invention facilitates the use of a high-power density and compact design of the electric motor arrangement.

The invention makes it possible to limit the losses inside the electronics of the electric motor arrangement, and in particular of the motor drive, to a minimum. The features of the motor drive may comprise any components, in particular electronic components, required for driving the electric motor.

Moreover, it helps separate circuits and components with different thermal properties from each other. To reduce heat losses and the requirement for forced cooling as much as possible, not only highly efficient circuits and components may be used such as e.g., SiC, GaN or IGBT switches, capacitors with low equivalent series resistance, but also the geometry and mechanical placement of the single components is relevant.

The present invention offers the advantage of an electric motor arrangement with a very compact design, which helps to reduce unnecessary energy losses and ensures very good behaviour in terms of EMI, thermal properties and energy efficiency.

Furthermore, the electronics of the electric motor arrangement are very easily scalable as the boards or PCBAs are divided by functions. In order to provide a bigger frame size or a bigger electric motor arrangement, only a new, i.e. bigger, power section with a corresponding housing or encapsulation is needed.

In a preferred embodiment of the invention, a first and second encapsulation portion contain components of the drive, wherein the first encapsulation portion, the second encapsulation portion and/or the motor are thermally separated from each other by at least one thermal isolating layer. A higher number of thermal insolating layers may result in better thermal separation for each encapsulation portion. The encapsulation portions may comprise separate housing components or shells, which protect the contents of the respective portion. The thermal isolating layers ensure that contents of the respective encapsulation portions may easily be kept at different temperature ranges during operation and without significant additional cooling requirements.

In another preferred embodiment of the invention, a motor cable is electrically connected to the power PCBA via a PCB cable connector and/or the stacked power module comprises an inverter for driving the motor.

In another preferred embodiment of the invention, the power connector comprises a female connector and a male connector. Either of the female or male connectors may be an input or an output connector. Providing a male and female connector ensures that the input and output connectors are not mixed up by personnel working on the motor arrangement. The female/male arrangement may also provide cascaded coupling of multiple motor drives in a network enabling bidirectional data communication between motor drives as well as power supply to each motor drive. The input and output connector may be industrial connectors.

Providing input and output connectors close to each other and/or soldering them to the same PCB while having the power module and, if necessary, all other relevant components close to each other ensures a good level of heat dissipation. Effective thermal management is thus facilitated. Also, the selection of suitable DC link capacitor technology, such as capacitors with low equivalent series resistance and/or film capacitors, is relevant for the thermal management of the device. For instance, electrolytic capacitors create more losses than film capacitors and require an additional balancing circuit, which again produce additional losses, further deteriorating the performance of the motor arrangement.

In another preferred embodiment of the invention, the first encapsulation portion is connected to the motor via the second encapsulation portion. Therefore, there may be less possible connection between the motor and the first encapsulation portion. This ensures that sufficient spacing is provided between the potentially hot motor and the second encapsulation portion, containing components operating at lower temperatures than the motor.

In another preferred embodiment of the invention, the second encapsulation portion is connected to an axial end of the motor. The axial direction may be referenced to the axis of rotation of the motor. The second encapsulation portion may be provided at an axial end opposite of an output shaft of the motor. The second encapsulation portion may be an intermediate portion, positioned between the motor and the first encapsulation portion and separating the motor from the first encapsulation portion. The second encapsulation portion may comprise the power electronics components e.g. the motor driving switches and/or the stacked power module.

In another preferred embodiment of the invention, the first encapsulation portion is spaced apart from the motor at least partially in a radial direction of the motor. The radial direction may be referenced to the axis of rotation of the motor, whereby the radial direction is perpendicular to the axis of rotation. A circumferential direction can be derived from said radial and axial directions.

In another preferred embodiment of the invention, a gap is provided between the first encapsulation portion and the motor. The gap may separate at least a portion of the first encapsulation portion from the motor. The gap may not contain any structural components of the motor arrangement, rather, it may be filled with whatever surrounding atmosphere the motor arrangement is exposed to. A section of the drive may overhang the motor. By providing a specific gap between motor and drive, a thermal coupling is avoided. The gap may preferably be more than ⅓ of the length of first encapsulation portion in the axial direction to reduce heat transfer from the second encapsulation portion and the motor to the first encapsulation portion.

In another preferred embodiment of the invention, the power PCBA is provided in the second encapsulation portion and/or a control PCBA is provided in the first encapsulation portion, wherein preferably a thermal pad is provided between at least one PCBA, in particular the control PCBA, and the first and/or second encapsulation portion, and wherein preferably the power PCBA and the control PCBA are connected to each other via a multi-pin connector, preferably at a 90° angle.

The power PCBA and the control PCBA may be the main heat-dissipating component in their respective encapsulation portion. Providing said PCBAs in thermally insulated encapsulation portions ensures that both PCBAs can be operated at their different maximum or ideal operating temperatures, without necessitating substantial forced cooling for either of the PCBA via e.g. a fan and/or a heat sink.

In another preferred embodiment of the invention, the first and second encapsulation portions fully enclose their respective interiors. The full enclosure signifies that no cooling air openings for cooling the inside of the encapsulation portions may be provided. The heat transfer from the inside of the encapsulation portions to the outside may occur substantially or exclusively via solid structures of the encapsulation portions and the motor, or more precisely, via their corresponding external walls or claddings.

A fan and/or a heat sink may therefore be avoided, which would otherwise reduce the ingress protection code rating of the encapsulation and/or risk clogging of the heat sink with correspondingly reduced cooling capabilities.

In another preferred embodiment of the invention, the first encapsulation portion, the second encapsulation portion and/or a motor casing of the motor are made of a metal material and/or have plane exterior faces. The plane exterior face may refer to a total lack of cooling ribs. The exterior faces of the encapsulation portions may therefore extend in parallel to the interiors faces of the encapsulation portions over their total or near total surface areas. The surface areas of the exterior faces of the encapsulation portions may correspond to 100% to 150%, preferably to 100% to 125% or 100% to 110%, of the surface areas of the interior faces of the encapsulation portions. The design of the motor arrangement may therefore be substantially simplified and/or its size reduced.

In another preferred embodiment of the invention, the first and/or second thermal isolating layer comprise a plastic material and/or a gasket sealing. The thermal isolating layers may be separate components from the encapsulations and the motor. The thermal isolating layers are provided between the encapsulations and the motor. The isolating layers may be squeezed in between the encapsulations and/or the motor.

In another preferred embodiment of the invention, a non-circulating air pocket is provided as a preferably only thermal conductor between the motor drive and the first and/or second encapsulation portions, and in particular between the power PCBA and the second encapsulation. No other or no dedicated heat-transferring medium or components other than air may be provided between some or all heat generating components of the motor drive and external walls of the first and/or second encapsulation portions. The lack of any dedicated heat-transferring medium or components enhances the serviceability and simplifies the construction of the motor arrangement. The components of the drive can be reached directly by opening the encapsulation and without the necessity to remove any present dedicated heat transferring medium or components.

In another preferred embodiment of the invention, the first and/or second encapsulation portion comprises a breather membrane between the inside and the outside of the first and/or second encapsulation portion. The breather membrane provides a connection between the inside and the outside of the first and/or second encapsulation portion, such that pressure gradients between the inside and the outside of the first and/or second encapsulation portion can be reduced or limited.

In another preferred embodiment of the invention, the motor, the first and/or the second encapsulation portion are screwed to each other with screws or fasteners and/or the thermal isolating layer is secured with screws within the first and/or second encapsulation portion. The screws may be inserted into the thermal isolating layers through corresponding holes. The screws may press the motor, the first and/or the second encapsulation portion against each other, such that the thermal isolating layer is compressed.

According to the second aspect of the invention comprising the features of claim 16, an electric motor arrangement is provided, which comprises an electric motor and first and second encapsulation portions containing a motor drive for driving the motor, wherein the first encapsulation portion, the second encapsulation portion and/or the motor are thermally separated from each other by at least one thermal isolating layer.

In order to account for the high compactness and power density of the motor drive, it is beneficial to divide the drive, or rather its different components, in different thermal sectors. The division of the components may depend on e.g. their function, power dissipation and/or temperature stability.

The thermal separation, i.e. the thermal isolating layer, is used as a sealing device for sealing the motor drive inside the encapsulation portions against the outside of the motor arrangement. The electric motor arrangement may hence have an ingress protection standard of e.g. IP 65 according to ISO 20653:2013-02 and no requirement for further cooling ribs such that high hygienic standards can be met, if required.

According to the second aspect of the invention, three different thermal sectors of the electric motor arrangement are provided, which divide the main enclosure of the motor arrangement in three different areas, e.g. cast parts: a first control part, or thermal sector, with most sensible components and thus lowest allowable operating temperatures, a second main circuit part with medium or high operating temperatures and a third motor part with highest operating temperatures.

When dividing the cast surfaces of the electric motor drive, or rather the electric motor and first and second encapsulation portions, in three distinct, separable parts, or thermal sectors, a corresponding sealing between the parts is provided according to the invention. The invention provides a thermal separation or a “splitter” between the three distinct parts, which, at the same time, serves as sealings/gaskets.

One major advantage of this aspect of the invention is that components with different operating temperature ranges can be combined easily in the same electric motor arrangement, albeit in different separable parts. For example, temperature sensitive components can be provided in a first part, robust low temperature components in a second part and high temperature components in a third part.

Furthermore, the parts with most power dissipation are separated from the other parts. At the same time, all parts have enough external surface area to dissipate the produced heat to the exterior of the electric motor arrangement.

In a preferred embodiment of the invention, a power PCBA is provided in the second encapsulation portion and/or a control PCBA is provided in the first encapsulation portion, wherein preferably a thermal pad is provided between at least one PCBA and the first and/or second encapsulation portion.

In another preferred embodiment of the invention, a non-circulating air pocket is provided as a preferably only thermal conductor between the motor drive and the first and/or second encapsulation portions.

In another preferred embodiment of the invention, the electric motor arrangement, in particular a servo-drive, complies with WEEE 2012/19/EU (Directive 2012/19/EU of the European Parliament and of the Council of 4 Jul. 2012 on waste electrical and electronic equipment (WEEE) consolidated version: Apr. 7, 2018), EN 50419:2006, ESG and/or IEC 60529-IP65 standards.

In another preferred embodiment of the invention, the motor, the first encapsulation portion, the control PCBA, the second encapsulation portion, and/or the power PCBA are removable from the electric motor drive arrangement. Servicing and replacing components is thus facilitated.

The lack of any dedicated heat-transferring medium ensures a better WEEE 2012/19/EU directive (Waste from Electrical and Electronic Equipment) fulfilment because parts may be easy to disassemble and dispose of.

The motor drive arrangement is specifically developed to fulfil ESG (Environmental, social, and corporate governance) compliance for products, concerning the reduction of waste energy losses in the electronic components, the scrapping/disposal of the product at the end of its life by separation/disassembly into individual parts and the possibility to replace individual parts of the motor drive arrangement and avoid scrapping the entire unit. A defect motor may be replaced by unscrewing it from the motor drive arrangement or by replacing a defective power PCBA with a working power PCBA.

The motor drive arrangement comprises the option to disassemble say the control PCBA from the motor drive arrangement to be replaced by e.g. a different type of control PCBA including new features, e.g. future network protocols, faster network speeds, lower wasted energy losses. It may also comprise replacement of the power PCBA to e.g. a different type with improved PWM switching speeds, lower waste energy losses. It may also comprise replacement of the motor with a different type on motor with different characteristics, e.g. higher torque, lower waste energy losses or replacement of worn bearings of the motor.

### BRIEF DESCRIPTION OF THE DRAWINGS

All features of the two aspects of the invention may be combined with each other in any logically feasible way and within the scope of the invention. Further details and advantages of the invention are described with reference to the embodiments shown in the figures. The figures disclose features, which may concern both aspects of the invention. The figures show:

FIG. 1: a first general view of the electric motor arrangement;

FIG. 2: a second view of components of the electric motor arrangement;

FIG. 3: a third view of components of the electric motor arrangement;

FIG. 4: a fourth view of components of the electric motor arrangement;

FIG. 5: a fifth view of components of the electric motor arrangement;

FIG. 6: a sixth view of components of the electric motor arrangement;

FIG. 7: a seventh view of components of the electric motor arrangement;

FIG. 8: an eighth general view of the electric motor arrangement;

FIG. 9: a ninth view of components of the electric motor arrangement; and

FIG. 10: a tenth general view of the electric motor arrangement.

### DETAILED DESCRIPTION

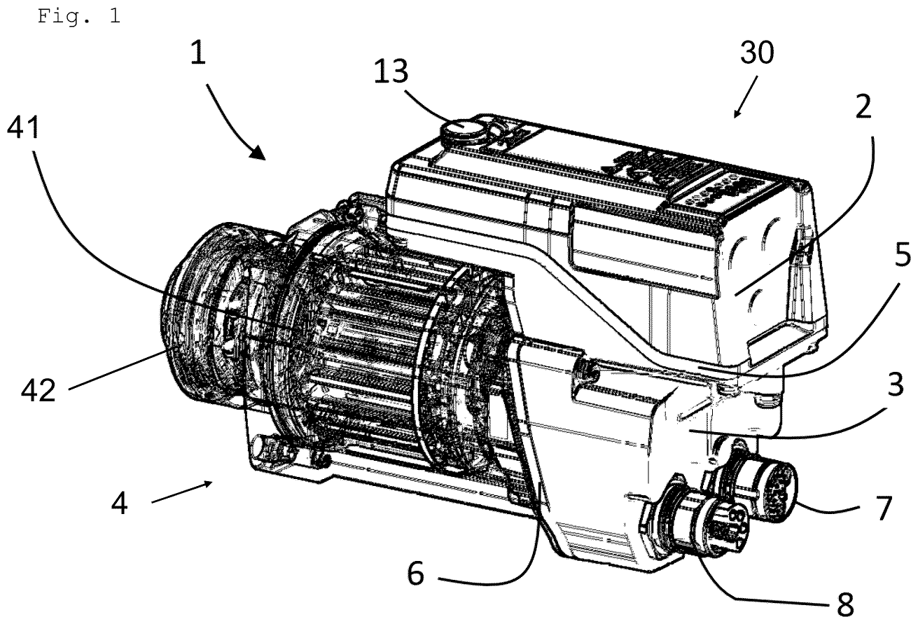

FIG. 1 shows a first general view of the electric motor arrangement 1. The electric motor arrangement 1 according to the first aspect of the invention comprises an electric motor 4, which may be a servo-integrated motor 4. The motor 4 comprises a motor casing 41 and is coupled to at least one encapsulation 2, 3. In the embodiment of FIG. 1, a first and second encapsulation 2, 3 are shown, containing a motor drive 30 for driving the motor 4. The motor drive 30 may comprise any components required for driving the electric motor 4.

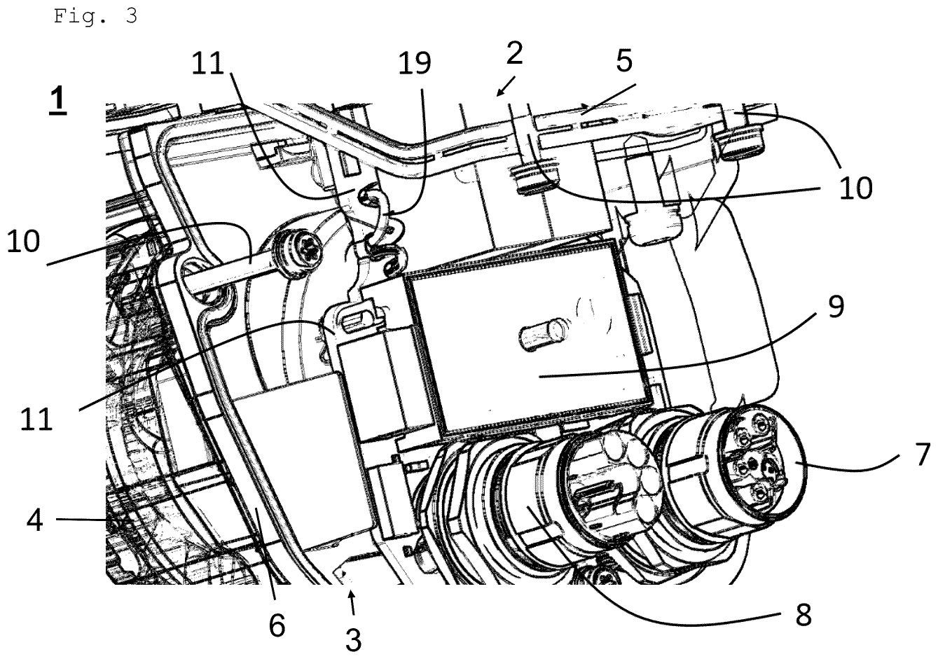

The motor drive 30 further comprises a power connector 7, 8, which is part of the low impedance electrical conducting path between the power connector 7, 8 a stacked power module 9 and a power PCBA 11, shown in e.g. FIG. 3. The power connector 7, 8 may be provided at the opposite end of an output shaft 42 of the motor 4. The power connector 7, 8 may be aligned in parallel to the axis of rotation of the motor 4. The term power connector 7, 8 may refer to one, two, or more separate power connector components 7, 8.

The present invention makes it possible to significantly reduce the heat dissipation of the electric motor arrangement 1. In particular, the low impedance electrical conducting path makes it possible to manage the heat dissipation within the specified, much reduced space of the motor arrangement 1. In order to reduce the heat dissipation, the impedance of the electrical conducting path may be smaller than 50 mOhm. The present invention facilitates the use of a high-power density and compact design of the electric motor arrangement 1, without the requirement of introducing additional cooling hardware, cooling ribs, heatsinks, ventilation slots and/or fans.

The invention makes it possible to limit the losses inside the electronics of the electric motor arrangement 1, and in particular the motor drive 30, to a minimum. The features of the motor drive 30 may comprise any components, in particular electronic components, required for driving the electric motor 4.

As implied by FIG. 1, circuits and components with different thermal properties may be provided in either of the two encapsulations 2, 3 and therefore spatially and thermally separated from each other. To reduce heat losses as much as possible, not only highly efficient circuits and components may be used, but also the geometry and mechanical placement of the individual components is relevant. In particular, heat tolerant components may be kept close to high temperature components, while heat sensitive components may be kept further away from high temperature components.

The present invention offers the advantage of a very compact design, which helps to reduce unnecessary losses and ensures very good behaviour in terms of EMI, thermal properties and efficiency. The two encapsulations 2, 3 may be arranged in proximity and/or direct contact to the motor 4, such that the entire electric motor arrangement 1 is formed as a compact and rigid component.

Furthermore, the electronics of the electric motor arrangement are very easily scalable as the boards or PCBAs are divided by functions. In order to provide a bigger frame size or a bigger electric motor arrangement 1, only a new, i.e. bigger, power section with a corresponding housing or encapsulation 2, 3 is needed.

The first encapsulation portion 2, the second encapsulation portion 3 and the motor 4 are thermally separated from each other by two thermal isolating layers 5, 6. The thermal isolating layers 5, 6 are indicated as narrow stripes between the encapsulation portions 2, 3 and the motor 4. The thermal isolating layers 5, 6 may be plane and/or flat structures extending between and contacting opposite contact portions of the encapsulation portions 2, 3 and/or the motor 4.

The encapsulation portions 2, 3 comprise separate housing components or shells, which protect the contents of the respective encapsulation portion 2, 3. The thermal isolating layers 5, 6 ensure that contents of the respective encapsulation portions 2, 3 may be kept at different temperature ranges during operation and without significant additional cooling requirements. Furthermore, the thermal isolating layers 5, 6 function as seals for preventing the intrusion of particles such as dirt particles into the encapsulation portions 2, 3 and therefor into the motor drive 30.

Power connector 7, 8 is provided for connecting the electric motor arrangement 1 to an electric power source. The power connector 7, 8 comprises a female power connector 7 and a male power connector 8. Either of the female or male connectors 7, 8 may be an input or an output connector 7, 8. Providing a male and female connector 7, 8 ensures that the input and output connectors 7, 8 are not mixed up by personnel working on the motor arrangement. The power connector 7, 8 may be arranged in parallel to an output shaft 42 of the motor 4. It may be provided at the second encapsulation portion 3, at a face opposite the motor 4. It may comprise protruding and/or at least partially cylindrical structures. The female and/or male connectors 7, 8 may also provide cascaded coupling of multiple motor drives 30 in a network, enabling bidirectional data communication between motor drives 30 as well as power supply to each motor drives 30.

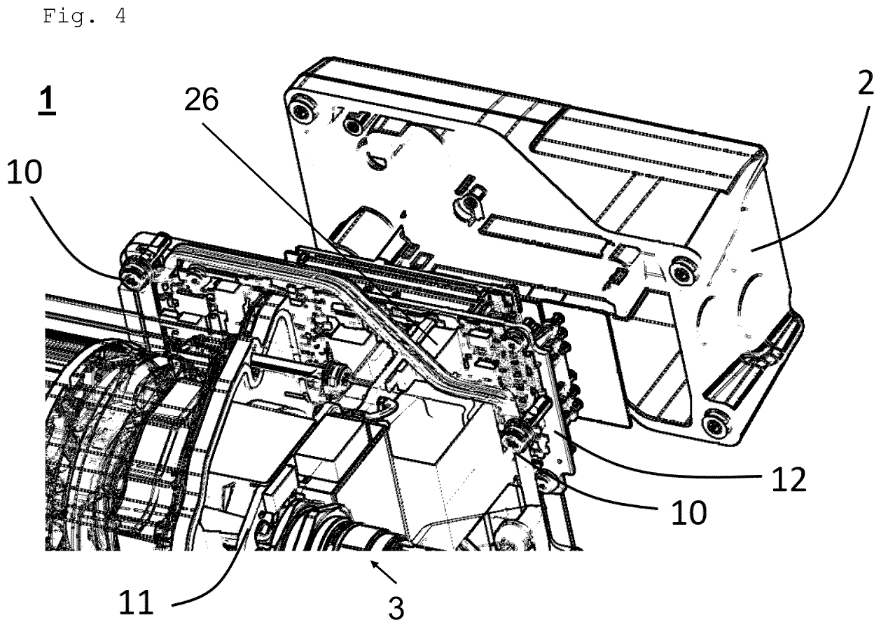

The input and output connectors 7, 8 are provided close to each other, whereby an outer diameter of the input and output connectors 7, 8 may be greater than the distance between the input and output connectors 7, 8. They may be soldered to the same PCBA 11 shown in FIG. 4. They may be arranged below the axis of the output shaft 42 while the first encapsulation portion 2 is provided above the axis of the output shaft 42.

A breather membrane 13 is provided at an upper portion of the first encapsulation portion 2. The breather membrane 13 may be provided at an upper face of the first encapsulation portion 2, opposite the motor 4. A hole within the first encapsulation portion 2 may be at least partially covered by the breather membrane 13.

The breather membrane 13 is provided between the inside and the outside of the first encapsulation portion 2. The breather membrane 13 provides a closable connection between the inside and the outside of the first encapsulation portion 2, such that pressure gradients between the inside and the outside of the first encapsulation portion 2 can be reduced or limited. The breather membrane 13 further increases IP protection, reduces stresses on sealings and gaskets and therefore increases their lifetime and also reduces moisture and condensation problems of the device. Alternatively, a breather membrane 13 may be provided at the second encapsulation portion 3.

The first encapsulation portion 2 is connected to the motor 4 via the second encapsulation portion 3. Therefore, there is no direct connection between the motor 4 and the first encapsulation portion 2. This ensures that sufficient distance, spacing and/or thermal isolation is provided between the potentially hot motor 4 and the first encapsulation portion 2, containing components operating at lower temperatures than the motor 4. The maximum extension of the first encapsulation portion 2 in the axial direction is equal to the maximum extension of the second encapsulation portion 3. The first encapsulation portion 2 and the second encapsulation portion 3 comprise matching contact surfaces, which are separated from each other by the first thermal isolating layer 5. The contact surfaces may have an identical outer perimeter.

The second encapsulation portion 3 is connected to an axial end of the motor 4, opposite its output shaft 42. The second encapsulation portion 3 is an intermediate portion, positioned between the motor 4 and the first encapsulation portion 2. and separating the motor 4 from the first encapsulation portion 2.

The first and second encapsulation portions 2, 3 fully enclose their respective interiors, with the exception of the breather membrane 13 providing some limited connection between the interior of the encapsulation portions 2, 3 and their exterior.

The full enclosure signifies that no cooling air openings for cooling the inside of the encapsulation portions 2, 3 are provided. The heat transfer from the inside of the encapsulation portions 2, 3 to the outside may occur substantially or exclusively via solid structures of the encapsulation portions 2, 3 and the motor 4, or more precisely, via their corresponding external walls or claddings.

The first encapsulation portion 2, the second encapsulation portion 3 and/or the motor casing 41 of the motor 4 are made of a metal material and/or have at least partially plane exterior faces. The plane exterior face may refer to a total or near total lack of cooling ribs. The design of the motor arrangement 1 may therefore be substantially simplified and/or its size may be reduced.

According to the second aspect of the invention, the electric motor arrangement 1 comprises the electric motor 4 and first and second encapsulation portions 2, 3 containing the motor drive 30 for driving the motor 4. The first encapsulation portion 2, the second encapsulation portion 3 and/or the motor 4 are thermally separated from each other by at least one thermal isolating layer 5, 6. In the embodiment of FIG. 1, all three components, i.e. the first encapsulation portion 2, the second encapsulation portion 3 and the motor 4 are thermally separated from each other by the first and second thermal isolating layers 5, 6. The thermal separation, e.g. the thermal isolating layers 5, 6, are simultaneously used as a sealing devices for sealing the motor drive 30 inside the encapsulation portions 2, 3 against the outside of the motor arrangement 1. The presently described features of the first and second aspect of the invention may be combined with each other in any logically possible way, while remaining within the scope of the present invention.

In order to account for the high compactness and power density of the motor drive 30, it is beneficial to divide the drive 30, or rather the different components of the motor arrangement 1, in different thermal sectors. The motor 4 and the first and second encapsulation portions 2, 3 may each be regarded as a different thermal sector of the motor arrangement 1.

The division of the components may depend on e.g. their function, power dissipation and/or temperature stability. In the presently described embodiment, the motor 4 and the first encapsulation portion 2 are coupled to each other via the second encapsulation portion 3. This means that there is no direct connection between the motor 4 and the first encapsulation portion 2.

According to the second aspect of the invention, the three different thermal sectors of the electric motor arrangement 1 divide a main enclosure, e.g. a cast part, in three different areas: a first control part, or thermal sector, with most sensible components, in particular of the motor drive 30, and thus lowest allowable operating temperatures, a second main circuit part, in particular of the motor drive 30, with medium or high operating temperatures and a third motor 4 part with highest operating temperatures of the electric motor 4.

When dividing the cast surfaces of the electric motor arrangement 1, or rather the electric motor 4 and first and second encapsulation portions 2, 3, in three distinct, separable parts, or thermal sectors, a corresponding sealing between the parts is provided in the shape of the thermal isolating layers 5, 6.

One major advantage of this aspect of the invention is that components with different operating temperature ranges can be combined easily in the same electric motor arrangement 1, albeit in different separable parts. For example, temperature sensitive components can be provided in a first part, robust low temperature components in a second part and high temperature components in a third part.

Furthermore, parts with highest power dissipation such as the electric motor 4 can be separated from other parts of the electric motor drive 1. At the same time, all parts of the electric motor drive 1 have enough external surface area to dissipate their respectively produced heat to the exterior of the electric motor arrangement 1.

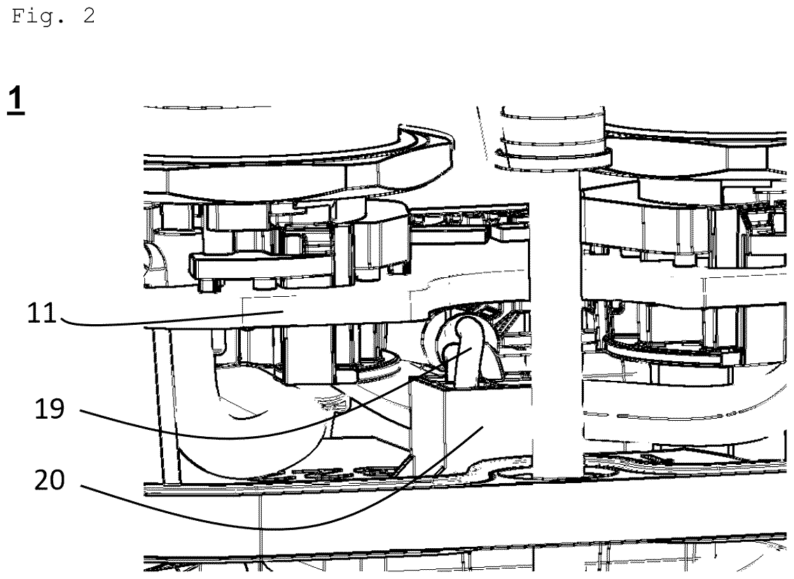

FIG. 2 shows a second view of components of the electric motor arrangement 1. A motor cable 19 is electrically connected to a power PCBA 11 of the motor arrangement 1 via a PCB cable connector 20.

FIG. 3 shows a third view of components of the electric motor arrangement 1. According to the first aspect of the invention, the motor drive 30 shown in FIG. 1 comprises a low impedance electrical conducting path with a stacked power module 9 and a power PCBA 11 provided inside the encapsulation 2, 3 of the motor drive 30 shown in FIG. 1. The stacked power module 9 may comprise an inverter for driving the motor 4. The power connectors 7, 8 are shown in close proximity to and below the stacked power module 9. The power connectors 7, 8 are part of the low impedance electrical conducting path.

The motor cable 19 is arranged on the opposite side of the stacked power module 9 with respect to the power connectors 7, 8. The power PCBA 11 may extend from the stacked power module 9 or the power connectors 7, 8 to a level above the motor cable 19

The motor 4, the first and/or the second encapsulation portion 2, 3, shown more comprehensively in FIG. 1, are screwed to each other with screws 10. Screws 10 for connecting the second encapsulation 3 to the motor 4 may be oriented in parallel to the power connectors 7, 8. Screws 10 for connecting the first encapsulation 2 to the second encapsulation 3 may be arranged perpendicular to the power connectors 7, 8 and/or to the screws 10 for connecting the second encapsulation 3 to the motor 4.

The thermal isolating layers 5, 6 may be secured with the same screws 10 within the first and/or second encapsulation portion 2, 3. The screws 10 may be inserted into the thermal isolating layers 5, 6 through corresponding holes. The thermal isolating layers 5, 6 may comprise further holes for connecting components of the first and second encapsulation portions 2, 3 with each other.

FIG. 4 is a fourth, partially exploded view of components of the electric motor arrangement 1. The power PCBA 11 is provided in the second encapsulation portion 3 while the control PCBA 12 is provided in the first encapsulation portion 2. The power PCBA 11 and the control PCBA 12 are connected to each other via a multi-pin connector 26, preferably at a 90° angle. Screws 10 for connecting the first and second encapsulation portion 2, 3 are shown extending in the same direction as the multi-pin connector 26.

The power PCBA 11 and the control PCBA 12 may be the main heat-dissipating component in their respective encapsulation portion 3, 2. Providing said PCBAs 11, 12 in thermally insulated encapsulation portions 3, 2 ensures that both PCBAs 11, 12 can be operated at their different operating temperatures, without necessitating substantial additional cooling for either of the PCBA 11, 12.

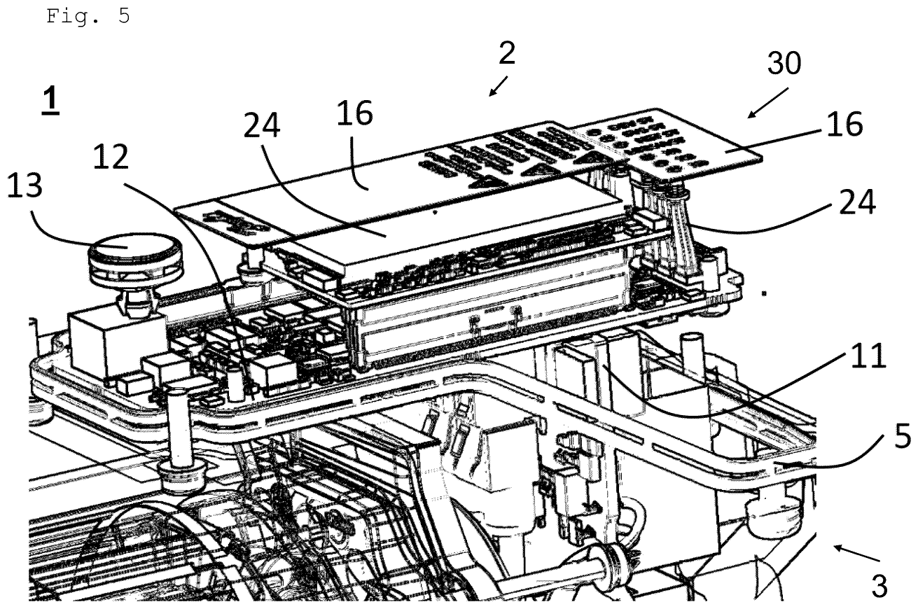

FIG. 5 is a fifth view of components of the electric motor arrangement 1. The first and second encapsulation portions 2, 3 are not visible in FIG. 5 and in further figures in order to show their respective contents. The first and second encapsulation portions 2, 3 are only indicated by arrows pointing in their general direction.

FIG. 5 and other figures therefore shows relevant interior components of the motor drive 30, without its external encapsulation portions 2, 3. The interior components of the motor drive 30 are surrounded partially or fully by air, in particular, a non-circulating air pocket within the first and second encapsulation portions 2, 3.

This air pocket may be the only thermal conductor between the motor drive's 30 internal components and its external housing, i.e. the first and second encapsulation portions 2, 3. This is particularly true for major heat generating components of the motor drive 30, such as the power PCBA 11 within its second encapsulation 3.

No further and/or no dedicated heat transferring medium or components other than air may be provided between some or all internal heat generating components of the motor drive 30 and walls of the first and/or second encapsulation portions 2, 3. The lack of any dedicated heat-transferring medium or components enhances the serviceability of the motor arrangement 1. The components of the motor drive 30 can be reached directly by opening the encapsulation 2, 3 and without the necessity to remove any present dedicated heat transferring medium or components.

In the embodiment of FIG. 5, a thermal pad 24 is provided between the control PCBA 12 and the first second encapsulation portion 2. The thermal pad 24 may provide an increased heat transfer capability between the control PCBA 12, the first encapsulation portion 2 and the exterior of the motor drive 30.

The breather membrane 13 provided at an upper portion of the first encapsulation portion 2 is shown in more detail. The breather membrane 13 connects the inside of the motor drive 30 to its outside. It may be positioned next to a label 16, provided at an outer or close to an inner surface of the first encapsulation portion 2. The thermal isolating layer 5 indicates the boundary between the two encapsulations 2, 3 of the motor drive 30.

According to one embodiment of the second aspect of the invention, the power PCBA 11 is provided in the second encapsulation portion 3 and/or the control PCBA 12 is provided in the first encapsulation portion 2.

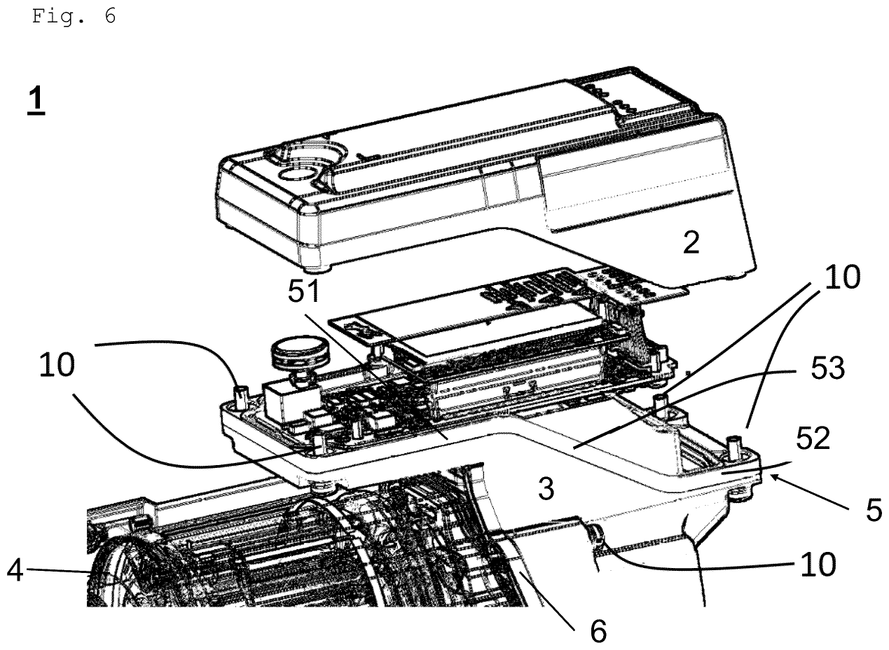

FIG. 6 shows a sixth view of components of the electric motor arrangement 1. The first and second thermal isolating layers 5, 6 are shown in their positions between the first and second encapsulation portions 2, 3 and the motor 4, respectively. The first thermal isolating layers 5 comprises two planar portions 51, 52, arranged in parallel to each other and separated from each other by an inclined portion 53. The first planar portion 51 is further away from the axis of rotation of the motor 4 than the second planar portion 52. The second thermal isolating layer 6 is arranged perpendicular to the two planar portions 51, 52 of the first thermal isolating layer 5.

The first encapsulation portion 2 is shown lifted from its assembled position. In the assembled position of the encapsulation portion 2, the encapsulation portion 2 is held in place by screws 10 and pushes against the first thermal isolating layers 5.

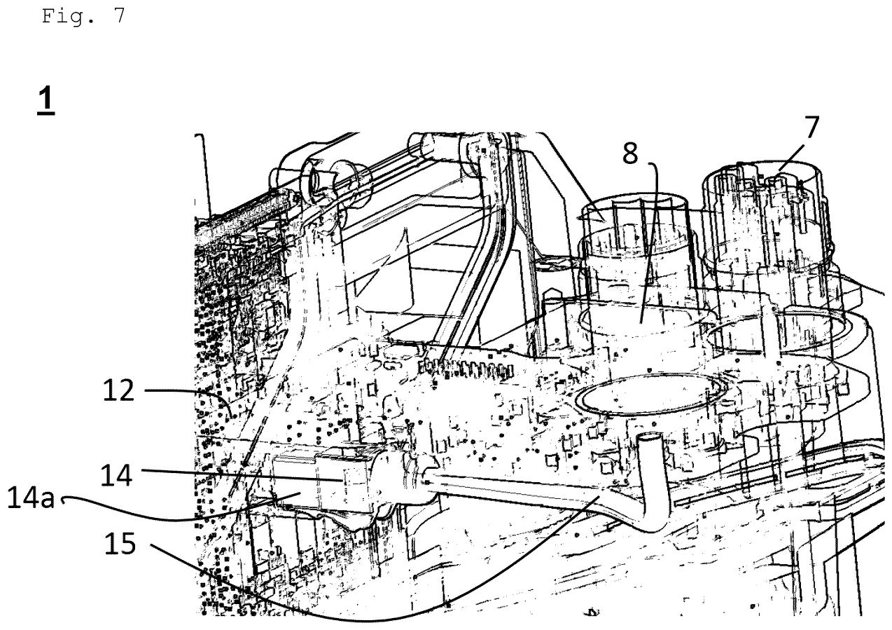

FIG. 7 shows a seventh view of components of the electric motor arrangement 1. The control PCBA 12 is connected to at least one of the power connectors 7, 8 via a Ethernet or Industrial connector 14, corresponding connector mating 14a and a multicore cable 15.

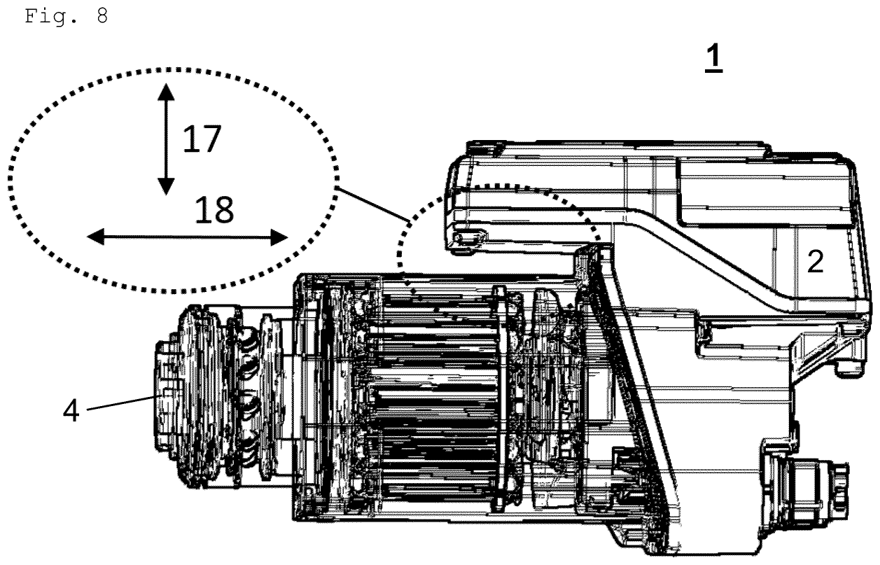

FIG. 8 shows an eighth general view of the electric motor arrangement 1. A free height 17 and a free length 18 are shown between the low temperature first encapsulation portion 2 and the high temperature motor 4. The corresponding gap between the first encapsulation portion 2 and the temperature motor 4 ensures that a heat transfer from the motor 4 to the first encapsulation portion 2 is minimized to a desired degree, while at the same time increasing the heat transfer away from the first encapsulation portion 2. The gap spaces apart the first encapsulation portion 2 from the motor 4 at least partially in a radial direction of the motor 4.

The gap spaces apart at least a portion of the first encapsulation portion 2 from the motor 4. The gap may not contain any structural components of the motor arrangement 1, rather, it may be filled with whatever surrounding atmosphere the motor arrangement 1 is exposed to. A section of the motor drive 30 may hence overhang the motor 4. By providing a specific gap between motor 4 and drive 30, a detrimental thermal coupling of the motor 4 and the motor drive 30 is avoided.

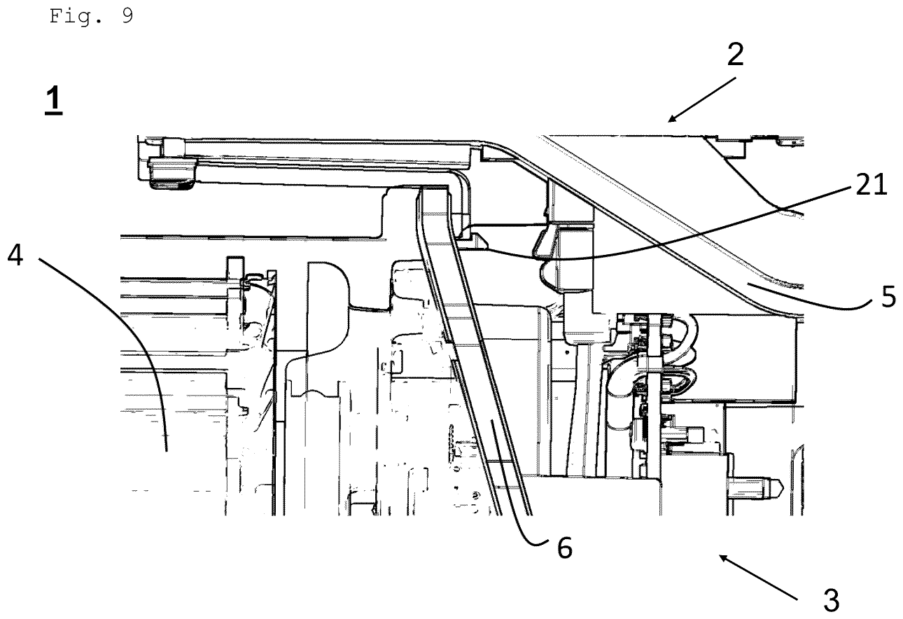

FIG. 9 shows a ninth view of components of the electric motor arrangement 1. A lock pin 21 of the second thermal isolating layer 6 is shown holding the second thermal isolating layer 6 in its place with respect to the second encapsulation portion 3. The second encapsulation portion 3 is not visible in FIG. 9, only its contents are shown for better clarity. Lock pins 21 may be provided between either of the thermal isolating layers 5, 6 on the one side and an adjacent structure, e.g. the encapsulation portions 2, 3 and/or the motor 4 on the other side. Any suitable number of lock pins 21 may be provided. The lock pins 21 may comprise a snap fit connection between the thermal isolating layers 5, 6 and their respective adjacent structure.

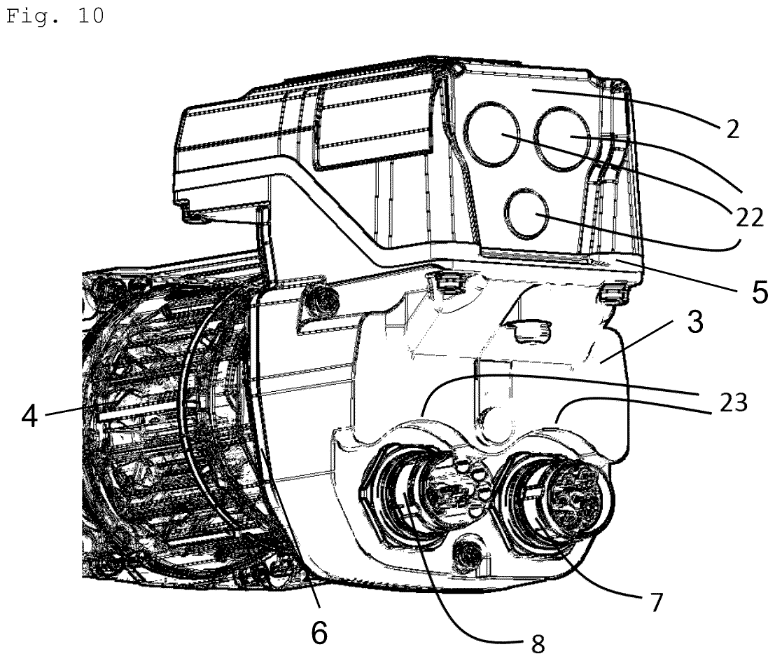

FIG. 10 shows a tenth rear view of the electric motor arrangement 1. The encapsulation portions 2, 3 are shown in their assembled states, wherein the thermal isolating layers 5, 6 are fixedly provided between the encapsulation portions 2, 3 and the motor 4. PG extension caps 22 according to standard DIN 40430 are provided at a rear side of the first encapsulation portions 2, arranged in parallel with the power connectors 7, 8. The second encapsulation portions 3 comprises one more connector indentations 23 for easily connecting cables to the power connectors 7, 8.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. An electric motor arrangement comprising an electric motor, in particular a servo integrated motor, an encapsulation containing a motor drive, in particular a servo drive, for driving the motor with a low impedance electrical conducting path comprising a stacked power module, a power PCBA and a power connector.

2. The electric motor arrangement according to claim 1, wherein a first and second encapsulation portion contain components of the drive, wherein the first encapsulation portion, the second encapsulation portion and/or the motor are thermally separated from each other by at least one thermal isolating layer.

3. The electric motor arrangement according to claim 1, wherein a motor cable is electrically connected to the power PCBA via a PCB cable connector and/or that the stacked power module comprises an inverter for driving the motor.

4. The electric motor arrangement according to claim 1, wherein the power connector comprises a female connector and a male connector.

5. The electric motor arrangement according to claim 2, wherein the first encapsulation portion is connected to the motor via the second encapsulation portion.

6. The electric motor arrangement according to claim 2, wherein the second encapsulation portion is connected to an axial end of the motor.

7. The electric motor arrangement according to claim 2, wherein the first encapsulation portion is spaced apart from the motor at least partially in a radial direction of the motor.

8. The electric motor arrangement according to claim 2, wherein a gap is provided between the first encapsulation portion and the motor.

9. The electric motor arrangement according to claim 2, wherein the power PCBA is provided in the second encapsulation portion and/or that a control PCBA is provided in the first encapsulation portion, wherein preferably a thermal pad is provided between at least one PCBA, in particular the control PCBA, and the first and/or second encapsulation portion, and wherein preferably the power PCBA and the control PCBA are connected to each other via a multi-pin connector, preferably at a 90° angle.

10. The electric motor arrangement according to claim 2, wherein the first and second encapsulation portions fully enclose their respective interiors.

11. The electric motor arrangement according to claim 2, wherein the first encapsulation portion, the second encapsulation portion and/or a motor casing of the motor are made of a metal material and/or have plane exterior faces.

12. The electric motor arrangement according to claim 2, wherein the first and/or second thermal isolating layer comprise a plastic material and/or a gasket sealing.

13. The electric motor arrangement according to claim 2, wherein a non-circulating air pocket is provided as a preferably only thermal conductor between the motor drive and the first and/or second encapsulation portions, and in particular between the power PCBA and the second encapsulation.

14. The electric motor arrangement according to claim 2, wherein the first and/or second encapsulation portion comprises a breather membrane between the inside and the outside of the first and/or second encapsulation portion.

15. The electric motor arrangement according to claim 2, wherein the motor, the first and/or the second encapsulation portion are screwed to each other with screws or fasteners and/or that the thermal isolating layer is secured with screws within the first and/or second encapsulation portion.

16. An electric motor arrangement comprising an electric motor and first and second encapsulation portions containing a motor drive for driving the motor, wherein the first encapsulation portion, the second encapsulation portion and/or the motor are thermally separated from each other by at least one thermal isolating layer.

17. The electric motor arrangement according to claim 16, wherein the first encapsulation portion is connected to the motor via the second encapsulation portion.

18. The electric motor arrangement according to claim 16, wherein the second encapsulation portion is connected to an axial end of the motor.

19. The electric motor arrangement according to claim 16, wherein the first encapsulation portion is spaced apart from the motor at least partially in a radial direction of the motor.

20. The electric motor arrangement according to claim 16, wherein a gap is provided between the first encapsulation portion and the motor.

21. The electric motor arrangement according to claim 16, wherein a power PCBA is provided in the second encapsulation portion and/or that a control PCBA is provided in the first encapsulation portion, wherein preferably a thermal pad is provided between at least one PCBA and the first and/or second encapsulation portion.

22. The electric motor arrangement according to a claim 16, wherein the first and second encapsulation portions fully enclose their respective interiors.

23. The electric motor arrangement according to claim 16, wherein the first encapsulation portion, the second encapsulation portion and/or a motor casing of the motor are made of a metal material.

24. The electric motor arrangement according to claim 16, wherein the first and/or second thermal isolating layer comprise a plastic material and/or a gasket sealing.

25. The electric motor arrangement according to claim 16, wherein a non-circulating air pocket is provided as a preferably only thermal conductor between the motor drive and the first and/or second encapsulation portions.

26. The electric motor arrangement according to claim 16, wherein the first and/or second encapsulation portion comprises a breather membrane between the inside and the outside of the first and/or second encapsulation portion.

27. The electric motor arrangement according to claim 16, wherein the motor, the first and/or the second encapsulation portion are screwed to each other with screws and/or that the thermal isolating layer is secured with screws within the first and/or second encapsulation portion.

28. The electric motor arrangement according to claim 1, in particular a servo-drive, wherein the motor drive complies with WEEE 2012/19/EU, EN 50419, ESG and/or IEC 60529-IP65 standards.

29. The electric motor arrangement according to claim 2, wherein the motor, the first encapsulation portion, the control PCBA, the second encapsulation portion, and/or the power PCBA are removable from the electric motor drive arrangement.
